(19) United States
(12) Patent Application Publication
(10) Pub. No.: US 2010/0103327 A1
(43) Pub. Date: Apr. 29, 2010

(54) VIDEO CONTROL UNIT

(75) Inventor: Matthieu Lentz, Paris (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/526,634

(22) PCT Filed: Feb. 7, 2008
(86) PCT No.: PCT/IB08/50436

§ 371 Date: Aug. 11, 2009

(30) Foreign Application Priority Data
Feb. 13, 2007 (EP) 07300791.6

(51) Int. Cl. H04N 9/64

(52) U.S. Cl. 348/714; 348/739

(57) ABSTRACT

Video control unit (set-top box), which is arranged firstly to assist calibration of whatever type of TV brand with test patterns included in the set-top box memory; secondly to acquire the specific display technology of the video display and the type of content of the received video signal and finally, according to the type of content and the display technology, to apply specific picture improvement algorithm, or fine-tune the existing picture.

### FIELD OF THE INVENTION

The invention relates to a video control unit for processing video signals and sending the so processed video signals to a video display. Such video control unit, that is often called “set-top box” (STB) serves to connect to a video display (TV receiver) and one or more external sources of signal, such as a satellite dish, a coaxial cable supplying TV signals, an ordinary VHF or UHF antenna, an Ethernet cable or even a telephone line with DSL connection. The basic function of the set-top box is to select and process the incoming signal so that it can be properly displayed on the connected video display.

### SUMMARY OF THE INVENTION

It is the purpose of the present invention to provide a set-top box that gives the user in all practical circumstances the best possible picture quality, while the signal optimization goes to a large extent automatically so that the end user has almost nothing to do. For that reason a first aspect of the video control unit of the present invention is characterized in that the video control unit comprises a non-volatile memory in which generic picture calibration information is stored and means to send that generic picture calibration information to the video display for enabling the user to optimize the video display. Preferably the video control unit is further characterized in that the generic picture calibration information is send to the video display when the video control unit is booted.

In this application the term “generic picture calibration information” is supposed to mean information that can be send to whatever type or brand of video display and with which the user can easily optimize such parameters as contrast, brightness, color (saturation), tint (hue) and sharpness of the picture. The generic calibration information may e.g. include 3 or 4 still picture test patterns. Such per se well-known test patterns may help the user to optimize the generic parameters of his display.

For this operation, any connection between the set-top box and the video display can be used, either analog (SCART, component, composite or Y-C connector) or digital (HDMI™). Also any type of display may be involved, from monitor, to rear projection, CRT or Flat TV. When booting the set-top box, a specific screen interface address “Picture Calibration” to set up the display is transferred from the set-top box to the display. When activated, the still picture test patterns are sent to the TV. The end user is then asked by the application to set up the correct value of brightness, color, contrast, tint and sharpness of his display. As usual the new values are stored in the video display for future use, so that the set up of the generic picture calibration information needs only to be done once.

Preferably the video control unit according to the invention may further be characterized by means to extract from the received video signal content-information-tables (DVB-SI tables) on the nature of the content (standard definition or high definition, Pal or NTSC-related, compression system used, etc.) and means to use said content information-tables to adapt the video signal to the nature of the content prior to sending the video signal to the video display. By this measure the type of the content that is watched by the user is taken into account for the calibration or modification of the video signal send to the video display. This measure takes into account that the setting of the signal parameters is different if the processed video signal is in high or standard definition, relates to sport events or to a show in standard definition, etc.

Valuable information on the content of the video signal can be extracted from the DVB SI tables (cf ETSI EN 300 468 v1.7.1 2005-08). We can specially focus on the Service Description Table (SDT), which is used to list names and other parameters of the services. In this table there are two descriptors of special interest:

The first one is the “component descriptor” which gives us the following information:
Standard definition or a High Definition content, MPEG2 or H264/AVC video compression system, PAL related or NTSC related system (25 Hz or 30 Hz).
The second one is the “content descriptor” which gives some more info of the content type, such as movie/drama, news/current affairs, show, game, sports, music . . .

Additionally the video control unit according to the present invention may be characterized by a user interface that enables the user to input parameters on the specific type of the video display (LCD, PLASMA, Cathode Ray tube, video projector, rear projector) connected to the video control unit, means to store said specific type parameters and means to use said parameters for adapting the video signal to be sent to the specific type of display. When the video control unit is booted a window could be displayed on the user interface of the set-top box. The application then asks the user to select the type of video display connected to the set-top box either LCD or plasma or CRT or video projector or rear projector. When this has been done once, the information is stored in the set-top box for all future occasions.

The Set Top Box is now aware of the type of content received (such as bit-rate, compression technology, TV system, High Definition) and the type of display technology used (such as LCD, PLASMA) to display the picture. With all these information it becomes very easy to adapt the content in order to get the best picture with no calibration anymore that has to be carried out by the end user.

The actions done by the set-top box may e.g. include:
adapting the gamma filter of the set-top box,
fine tuning the picture enhancement algorithm (example LTI filter),
fine tuning the deblocking/ deringing algorithm, i.e. either minimize it or suppress it if bit rate is good enough.

In case the video display is connected to the video control unit through a HDMI-connection the user interface for inputting the parameters on the specific type of the video display can be dispensed with and the video control unit of the present invention may be characterized by means to receive, through specific descriptor in the HDMI standard, parameters on the specific type of the video display (lcd, plasma, crt, video projector, rear projector), means to store said specific type parameters and means to use said parameters for adapting the video signal to be sent to the specific type of display.

### BRIEF DESCRIPTION OF THE DRAWINGS

The invention will be further explained with reference to the accompanying drawing. Herein shows

FIG. 1 the architecture of a video control unit in which the invention is used and

FIG. 2 an example of a video display of a user interface for enabling the user to select parameters on the type of video display used.

### DETAILED DESCRIPTION OF THE EMBODIMENTS

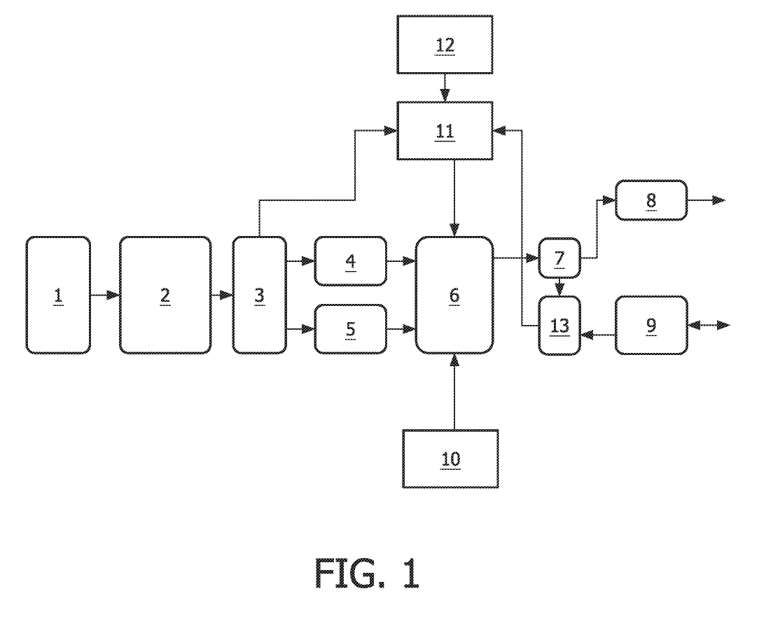

The video control unit of FIG. 1 comprises usual elements such as a tuner 1, a demodulation stage 2, a demultiplexer 3 for demultiplexing the received video and audio signals, a video decoder 4, an audio decoder 5 and post-processing circuitry 6 for processing the decoded video- and audio-signals. In the block diagram of FIG. 1 the arrows indicate the main signal transfer between the blocks.

The signals from the post-processing circuitry 6 are applied through an audio/video-switch 7 to either a digital HDMI output 9 via the HDMI parser 13 or an analog output 8. This analog output may typically be a SCART-, a component- or a composite-connector.

The video control unit of FIG. 1 further comprises a non-volatile memory 10. This non-volatile memory has stored generic picture calibration information such as for instance a chart with a color bar, a chart with a multiburst bar and a chart to facilitate the brightness and contrast settings of the video display. This information is applied to the post-processing circuitry, there added to the video channel of the video control unit and so send to the video display connected to the video control unit.

Information on the nature of the content of the received video signal is extracted from the video signal in the demultiplexer 3 and stored in a volatile memory 11. This information is used in the post-processing circuitry 6 to appropriately modify the video signal e.g. to modify the bit rate of the signal.

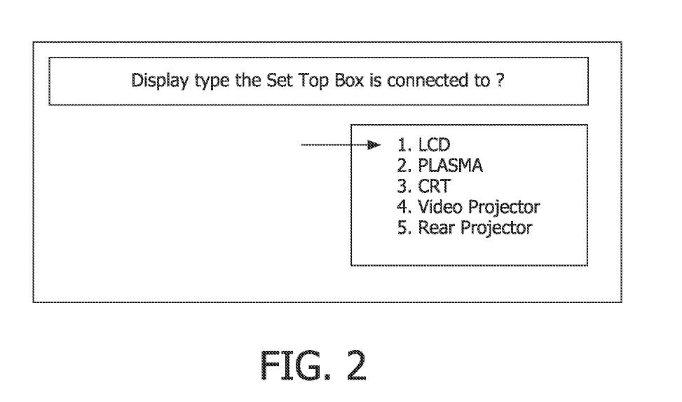

Finally also specific information on the type of the video display is stored in the volatile memory 11 and applied to the post-processing circuitry. This specific information may be input by the user by means of a user interface 12, stored in the volatile memory 11 and subsequently used to modify the signal in the post-processing circuitry 6. The user interface 12 may preferably contain an interface display that displays a selection menu as shown in FIG. 2. Alternatively, in case the video display is connected to the video control unit through the HDMI interface 9, this specific information is gathered automatically via the HDMI parser 13 and sent to the volatile memory 11 before being sent on the video display for confirmation.

1. Video control unit for processing video signals and sending the so processed video signals to a video display characterized in that the video control unit comprises a non-volatile memory (10) in which generic picture calibration information is stored and means (6,7,8,9) to send that generic picture calibration information to the video display for enabling the user to optimize the video display.

2. Video control unit as claimed in claim 1 characterized in that the generic picture calibration information is send to the video display when the video control unit is booted.

3. Video control unit as claimed in claim 1 characterized by means (3) to extract from the received video signal content-information-tables (DVB-SI tables) on the nature of the content and means (6) to use said content information-tables to adapt the video signal to the nature of the content prior to sending the video signal to the video display.

4. Video control unit as claimed in claim 1 characterized by a user interface (12) that enables the user to input parameters on the specific type of the video display connected to the video control unit, means (11) to store said specific type parameters and means (6) to use said parameters for adapting the video signal to be sent to the specific type of display.

5. Video control unit as claimed in claim 1 comprising an HDMI connector (9) for connection to the video display, characterized by means (13) to receive, through the HDMI connector, parameters on the specific type of the video display, means (10) to store said specific type parameters and means (6) to use said parameters for adapting the video signal to be sent to the specific type of display.
